(19) United States
(12) Patent Application Publication
(10) Pub. No.: US 2022/0253720 A1
(43) Pub. Date: Aug. 11, 2022

(54) BESPOKE DETECTION MODEL

(71) Applicant: BAE SYSTEMS plc, London (GB)

(72) Inventors: Benjamin Thomas Chehade, London, Greater London (GB); Markus Deittert, Bristol South Gloucestershire (GB); Simon Jonathan Mettrick, New Malden Surrey (GB); Yohahn Aleixo Hubert Ribeiro, New Malden Surrey (GB); Frederic Francis Taylor, Portsmouth Hampshire (GB)

(73) Assignee: BAE SYSTEMS plc, London (GB)

(21) Appl. No.: 17/432,253

(22) PCT Filed: Feb. 19, 2020
(86) PCT No.: PCT/GB2020/050389

§ 371 Date: Aug. 19, 2021

(30) Foreign Application Priority Data
Feb. 22, 2019 (GB) 1902457.9

(51) Int. Cl. G06N 5/02; G06N 5/04

(52) U.S. Cl. CPC G06N 5/022; G06N 5/043

(57) ABSTRACT

The present invention relates to a method of classifying behaviour patterns. The method comprises configuring a simulation environment based on an operational arena, configuring an artificial agent to carry out a chosen activity within the simulation environment, generating training data from the agent's activity, and training a detection model using the training data.

The present invention relates to a method of detecting and classifying behaviour patterns, and specifically to a fully adaptable/bespoke system adapted to simulate multiple situations and environments in order to provide bespoke training data for a behaviour classifying system.

### BACKGROUND

Computer enabled detection models concern the detection of particular behaviour at specific locations from real world data, e.g. radar tracks. Example behaviour might be the trafficking of illegal immigrants across the English Channel in early spring. Previously, the key problem has been the absence of training data that comprises labelled suspicious activity of the desired type to be detected. However, intelligence on likely routes, vessels, speeds, start areas and destinations is available. The present invention aim to create an artificial “adversarial” agent, i.e. an AI component that behaves like an actor engaged in an activity to be detected, and use the artificial agent to create realistic synthetic training data for a deep neural network. The artificial agent, as well as the bespoke detection model, can be trained in situ and when required. The simulated models can be updated regularly, e.g. once a day, as intelligence updates are received.

### SUMMARY OF INVENTION

According to a first aspect of the present invention, there is provided a method and system as described by the claims.

### FIGURES

For a better understanding of the invention, and to show how embodiments of the same may be carried into effect, reference will now be made, by way of example, to the accompanying diagrammatic figures in which:

FIG. 1 is a flowchart of an example method; and

FIG. 2 is a schematic illustration of an example classifying system.

### DESCRIPTION

In the example discussed, we are focused on a marine environment, and detecting suspicious behaviour such as people trafficking. However, it will be appreciated the present method and system can be applied to a range of situations wherein there is a need or desire for bespoke simulation and training for behaviour detection.

The present system and method aim to provide the following features within a bespoke detection model:

a track classification component that is classifying a particular suspect behaviour;

a track classification component that has been trained using training data bespoke for the area, time and type of activity;

creating synthetic track data sets without knowing a priori the relevant distributions;

capturing human expert knowledge with respect to the nature of the expected suspicious behaviour;

discovering relevant suspect behaviours through reinforcement learning and guidance by a human domain expert; and

generating synthetic training data from a mix of historic data and simulation with intelligent agents

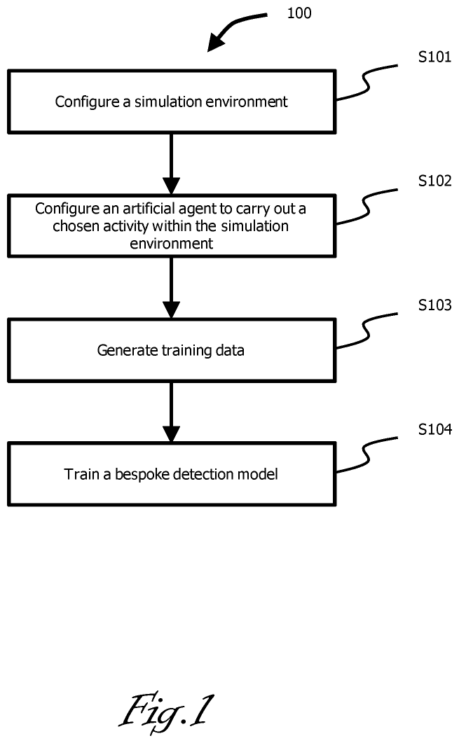

FIG. 1 shows a flowchart of an example method according to the present invention. The method creates a bespoke detection model from vague or incomplete intelligence data points, by providing synthetic training data from an artificial “adversarial” agent.

As the first step, a simulation environment is configured using a human domain expert, such as a Royal Navy (RN) officer. Typically, one simulation environment is required per suspicious activity.

In a second step, the human domain expert also configures an artificial “adversarial” agent to carry out a chosen activity within the simulation environment. The human domain expert translates their understanding of likely suspicious activity, as well as recent intelligence reports into machine readable configuration data for a simulation environment. Parameters of the agent and the chosen activity include:

likely starting areas of the activity;

starting times;

destination areas;

vessel choice;

speed limits;

behaviour such as detection avoidance and/or erratic steering etc.

In a third step, the simulation environment is used to train the artificial agent to discover good strategies for the chosen “suspicious” activity. If, for example, the activity to be detected is human trafficking, the artificial agent would learn which routes to take to reach the destination(s), how to avoid detection by other marine traffic and such like. The artificial agent is thus able to create motion patterns and synthetic track data that is representative of the real behaviour.

In the final step, the bespoke detection model is trained using the synthetic training data created in the previous step.

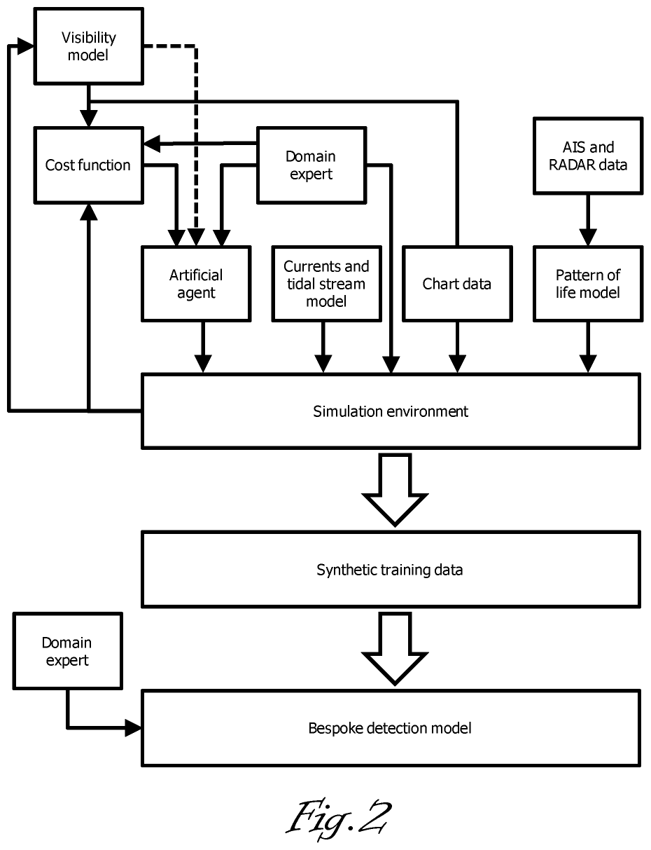

FIG. 2 shows the components of an example system adapted to carry out the method described above. The systems comprises the following components:

Pattern of Life Model—The Pattern of Life (PoL) model is a generative model that produces typical tracks and background traffic for a given area and time. A number of different approaches for implementing such a model exist, however, the model's particulars are typically derived from historic data such as AIS and/or RADAR data.

AIS and RADAR Data—The historic track data is used to train the pattern of life model. This data may either span large historic periods, e.g. years, or may be recent, e.g. own ship observations spanning the last week, or both.

Chart Data—The chart data describes the geographical features such as the depth of any water, and the position of the coastline. The chart data is used by the simulation environment to prevent the artificial agent from moving across land or too shallow a water body.

Current and Tidal Stream Model—This model provides data on the tidal stream and the prevailing ocean currents to the simulation environment. It is dynamic and accurate for a given time/date in the geographical region being simulated.

Domain Expert—The domain expert's job is to translate their own knowledge and other intelligence reports into configuration data for the simulation environment. They also provide information to help the behaviour of the artificial agent.

Cost Function—The cost function is a component of the artificial agent training. The cost function computes the feedback signal that the artificial agent receives during training. The feedback signal is a scalar value that is computed during particular events in the simulation. The cost function may also be a vector cost function in other examples. Consider the case of detecting people trafficking across the Channel. The agent receives a large positive feedback signal from the simulation environment if it arrives at the destination region within the prescribed time window, but receives a negative feedback signal if detected by any other vessel en-route. The cost function makes use of both the visibility model and the chart data, and is configured by the domain expert through a Graphical User Interface (GUI).

Visibility Model—The visibility model informs the cost model if the artificial agent is visible to other traffic in the surrounding area. It also informs the artificial agent of any tracks that it can see.

Artificial “Adversarial” Agent—This is an intelligent agent that discovers near optimal behaviour for the suspicious behaviour that the bespoke detection model intends to detect. The agent in trained in a simulation environment and discovers suitable strategies from the feedback provided by the cost function. A candidate approach for implementing this agent is Deep Deterministic Policy Gradient (DDPG) which as a sub-variant of Reinforcement Learning (RL). However, other approaches can be used instead. There are two key requirements for the artificial agent's implementation and learning approach:

i) learning must be unsupervised; and

ii) the agent must provide a mapping from state space to action space. Another candidate approach is Learning Classifier Systems (LCS) or a variant thereof. Random walk is a poor basis for learning where to steer to, and the explorative behaviour must be more guided.

Simulation Environment—A simple simulator that is used to train the artificial agent and create synthetic track data for training of the detection model.

Synthetic Training Data—The synthetic training data is created using the simulation environment in conjunction with the pattern of life model and the trained artificial agent. It comprises track histories derived from multiple simulations. The initial conditions and final condition constraints for each simulation run are created by sampling the distributions elicited from the domain expert.

Bespoke Detection Model—The bespoke detection model is a detection model for a particular suspect activity that has been trained using training data that is bespoke to the considered activity, location and time. In use, the bespoke detection model classifies observed tracks into either normal or suspicious, where a bespoke model instance is used to detect each particular suspicious activity. The model analyses individual tracks or groups of such tracks. The model's input data also includes the position history for each known track. A large number of approaches exist in how to implement this model. However, in the present example, the models are trained or tuned using training data that is bespoke with respect to the location, time and type of suspect activity to be detected. In the present example, a feature vector is created for each known track in the tactical picture, and each feature vector is classified in turn. Candidate features include:

start point;

average speed;

straightness;

closest point of approach;

bounding box of track;

current position; and

average heading.

Therefore, we are able to train a detection model to detect and identify/classify sought-after behaviours and actions by preparing training data from an artificial agent.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of training a detection model, the method comprising:
configuring a simulation environment based on an operational arena;
configuring an artificial agent to carry out a chosen activity within the simulation environment;
generating training data from the agent's activity; and
training a detection model using the training data.

2. The method according to claim 1, further comprising: observing real life data, and using the detection model to classify the behaviour.

3. The method according to claim 1, wherein the training data incorporates historical data and/or human knowledge.

4. The method according to claim 3, wherein the historical data is obtained from radar tracks.

5. The method according to claim 1, wherein the artificial agent activity is scored against a scalar cost function.

6. The method according to claim 1, wherein the artificial agent generates synthetic track data for training of the detection module.

7. The method according to claim 1, wherein the simulation environment is configured for a particular geographical location and/or a particular time period.

8. The method according to claim 1, wherein the simulation environment and/or the training data is periodically updated as intelligence is gathered.

9. The method according to claim 1, wherein the artificial agent is left to train unsupervised.

10. The method according to claim 1, wherein the simulation environment is bespoke to the activity to be detected.

11. The method according to claim 1, wherein the artificial agent takes into account visibility of the agent whilst carrying out the chosen activity.

12. The method according to claim 1, wherein the simulation environment comprises background traffic and activity.

13. A system comprising one or more processors and storage encoded with instructions that when executed by the one or more processors cause a process to be carried out for training a detection model, the process comprising:
configuring a simulation environment based on an operational arena;
configuring an artificial agent to carry out a chosen activity within the simulation environment;
generating training data from the agent's activity; and
training a detection model using the training data.

14. The system according to claim 13, wherein the training data incorporates historical data obtained from radar tracks and/or synthetic track data generated by the artificial agent, and wherein the artificial agent activity is scored against a scalar cost function.

15. The system according to claim 13, wherein the simulation environment is configured for a particular geographical location and a particular time period.

16. A non-transient machine-readable medium encoded with instructions that when executed by one or more processors cause a process to be carried out for training a detection model, the process comprising:
configuring a simulation environment based on an operational arena;
configuring an artificial agent to carry out a chosen activity within the simulation environment;
generating training data from the agent's activity; and
training a detection model using the training data.

17. The non-transient machine-readable medium according to claim 16, the process further comprising: observing real life data, and using the detection model to classify the behaviour.

18. The non-transient machine-readable medium according to claim 16, wherein the training data incorporates historical data and/or human knowledge, wherein the historical data is obtained at least in part from radar tracks.

19. The non-transient machine-readable medium according to claim 16, wherein the artificial agent activity is scored against a scalar cost function.

20. The non-transient machine-readable medium according to claim 16, wherein the artificial agent generates synthetic track data for training of the detection module.
